(19) United States
(12) Patent Application Publication
(10) Pub. No.: US 2009/0257030 A1
(43) Pub. Date: Oct. 15, 2009

(54) IMAGE PROJECTOR WITH TIME-SEQUENTIAL INTERLACING

(75) Inventors: Tomasz L. Klosowiak, Glenview, IL (US); Zili Li, Barrington, IL (US); Ion V. Nicolaescu, Carpentersville, IL (US); Xiaodong Xun, Schaumburg, IL (US)

Correspondence Address: MOTOROLA, INC., 1303 EAST ALGONQUIN ROAD, IL01/3RD, SCHAUMBURG, IL, 60196, US

(73) Assignee: Motorola, INC., Schaumburg, IL (US)

(21) Appl. No.: 12/100,768

(22) Filed: Apr. 10, 2008

(51) Int. Cl. G03B 21/14

(52) U.S. Cl. 353/30; 353/121

(57) ABSTRACT

Disclosed are a system and method for microprojection that uses a “reduced-height” imager to sequentially display a series of partial images within one frame time. The partial images visually combine on a projection surface (e.g., a screen or a wall) into one high-resolution projected image. As a result, the microprojector projects an image with a resolution equal to the sum of the resolutions of the individual partial images while avoiding the use of very small imager optics with their lowered efficiency. For example, one embodiment projects exactly two partial images during each frame. During a first state of operation, a “half-height” imager displays the odd-numbered lines of the projected image. During a second state of operation, the imager displays the even-numbered lines of the projected image. By quickly cycling through these two states, no image flickering between phases is visible, and the combined image appears as a seamless whole.

### FIELD OF THE INVENTION

The present invention is related generally to projection of optical images, and, more particularly, to optical-image projectors subject to space limitations.

### BACKGROUND OF THE INVENTION

A trend in personal portable devices (such as cell phones and personal digital assistants) is to add new features while keeping the devices small. Many of the new features, such as photograph sharing and video downloading, depend upon a high resolution, easy-to-read display screen. However, manufacturers cannot simply keep increasing the size of their display screens because that would eventually run counter to the desire to keep the devices small and portable.

Recently, “microprojectors,” a new category of display device, have been designed to address this conflict between greater display area and smaller device size. An image, either still or moving, is projected from the device onto a convenient surface (e.g., a projection screen or an office wall). The maximum size of the image is then effectively constrained by the amount of available wall space rather than by the size of the device itself. Using a microprojector-equipped device, several people can simultaneously view a photograph, for example, or review a full page of text, neither of which can be readily done with even the largest displays on current personal portable devices.

Promising as they are, microprojectors raise new headaches when engineers attempt to fit them into personal portable devices. While the overall size of the projected image may be effectively unlimited, expanding the image size is of little use if the resolution of the projected image is severely constrained. What customers want is a projected image that is both larger overall and has much greater resolution than a device's display screen. But, generally, the overall size of a microprojector grows with the amount of resolution it provides. This is especially true when a microprojector uses a microdisplay imager as its image source. The trend toward very thin personal portable devices renders it a challenge to fit in a microprojector that provides usefully high resolution.

Power use is another challenge. By its nature, a microprojector uses a significant amount of power to light a large display area. Reducing the physical size of the microprojector exacerbates the power problem because the optics in microprojectors become less power-efficient as they become smaller. Designers of battery-based personal portable devices are already concerned about their power budgets and look askance at any new feature that threatens to reduce the utility of the device by reducing how long the device can operate between charges.

### BRIEF SUMMARY OF THE INVENTION

The above considerations, and others, are addressed by the present invention, which can be understood by referring to the specification, drawings, and claims. According to aspects of the present invention, a microprojector uses a “reduced-height” imager to sequentially display a series of partial images within one frame time. The partial images visually combine on a projection surface (e.g., a screen or a wall) into one high-resolution projected image. As a result, the microprojector projects an image with a resolution equal to the sum of the resolutions of the individual partial images while avoiding the use of very small imager optics with their lowered efficiency.

For example, one embodiment projects exactly two partial images during each frame. During a first state of operation, a “half-height” imager displays the odd-numbered lines of the projected image. During a second state of operation, the imager displays the even-numbered lines of the projected image. By quickly cycling through these two states (e.g., performing each state 24 or 32 times per second), no image flickering between phases is visible, and the combined image appears as a seamless whole.

By increasing the number of operational states, the projected image can be divided into more partial images, and the imager can be made even thinner.

Line-processing optics are used in some embodiments to reduce the vertical “thickness” of the horizontal lines of the projected partial image. Then, the lines projected during one state of operation can visually fit between the lines projected during the other states of operation.

Some embodiments employ a switchable beam shifter to position the partial images with respect to one another so that, when projected, the partial images interlace to form a seamless image without overlap. In an embodiment where two partial images are projected, for example, the beam shifter in one state raises the odd-numbered lines just enough (in conjunction with the narrowing produced by the line-processing optics, if any) so that the even-numbered lines fit between them.

Because the height of the imager is smaller than the height of a monolithic imager that could project an image with the same resolution, the imager can fit into a very thin device. The combined image has a resolution equal to the sum of the resolutions of the partial images. That is, the combined image has a horizontal resolution equal to that of the imager and a vertical resolution equal to the vertical resolution of the imager multiplied by the number of partial images projected during one frame.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representative environment in which aspects of the present invention can be practiced;

FIG. 2a is a simplified schematic view of an exemplary time-sequential microprojector with a reduced-height imager, the microprojector being in a first phase of operation;

FIG. 2b shows the image produced by the microprojector of FIG. 2a during its first phase of operation;

FIG. 2c is a schematic of the same microprojector as in FIG. 2a, but now in its second phase of operation;

FIG. 2d shows the image produced by the microprojector of FIGS. 2a and 2c during its second phase of operation;

FIG. 3 is a flowchart of an exemplary embodiment of the present invention; and

FIG. 4 is a schematic showing how line-processing optics and a switchable beam shifter work together in some embodiments.

### DETAILED DESCRIPTION OF THE INVENTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

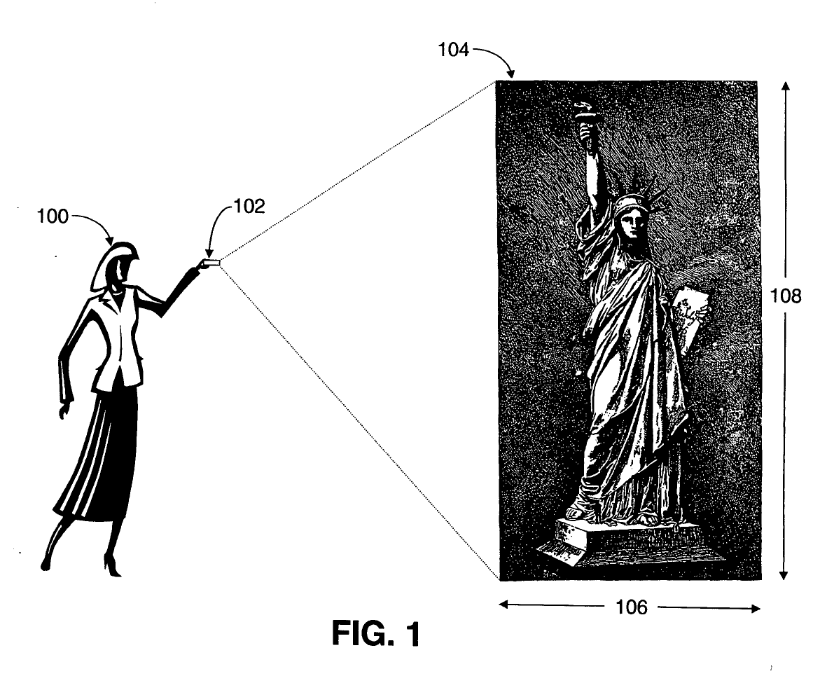

In FIG. 1, a user 100 is projecting an image 104 from her personal portable device 102. The image 104 could be, for example, a photograph, a video, or a computerized display from a word processor or an Internet browser. The image 104 may be projected onto a screen or even onto a wall or ceiling. By projecting the large, high resolution image 104 rather than presenting it on a (necessarily small) display screen of her personal portable device 102, the user 100 can invite others to share the image 104 with her.

The resolution of a digital image is defined as the product of its horizontal resolution and its vertical resolution. Resolution is measured in number of pixels. In FIG. 1, the image 104 has a horizontal resolution “Rx.” Rx measures the number of addressable pixels in the horizontal direction and is indicated by 106 in FIG. 1. The vertical resolution “Ry” counts addressable pixels in the vertical direction and is indicated by 108. Note that here “horizontal” and “vertical” are merely convenient, and conventional, names for the two dimensions of a planar image, and are not confined to orientations taken with respect to the direction of gravity.

In a projector, an “imager” is a device that modulates light in order to imprint image information into a projected light beam. Generally, the resolution of a projected image is equal to the resolution of the imager that creates the image. Traditionally, including within the personal portable device 102 an imager that provides acceptable resolution for the projected image 104 makes the personal portable device 102 both thick and bulky. The present invention addresses this issue by allowing a small and thin personal portable device 102 to project a large, high resolution image 104.

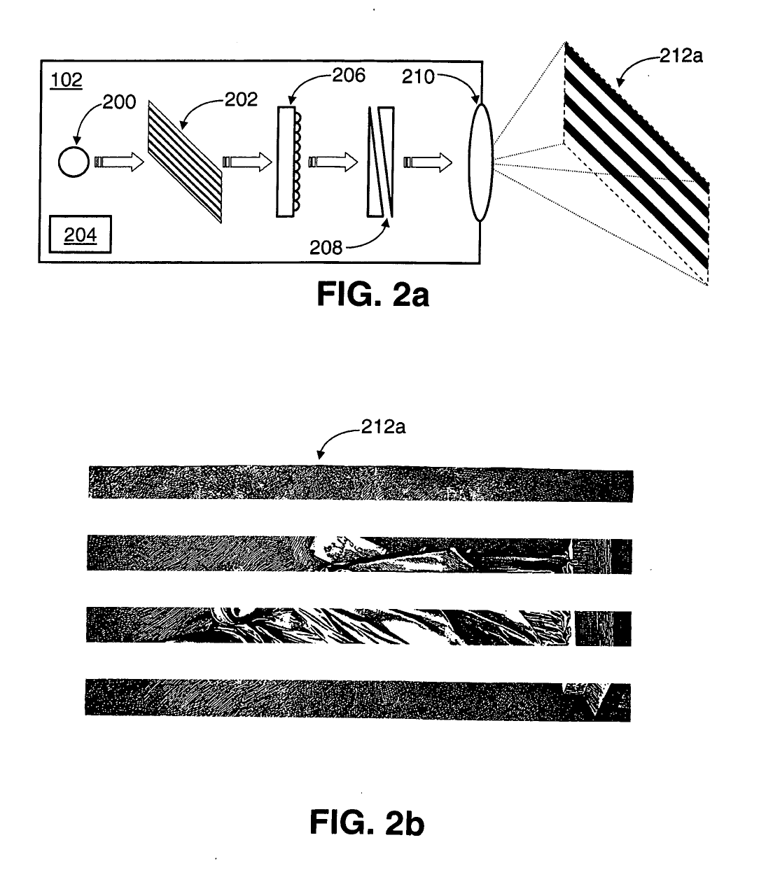

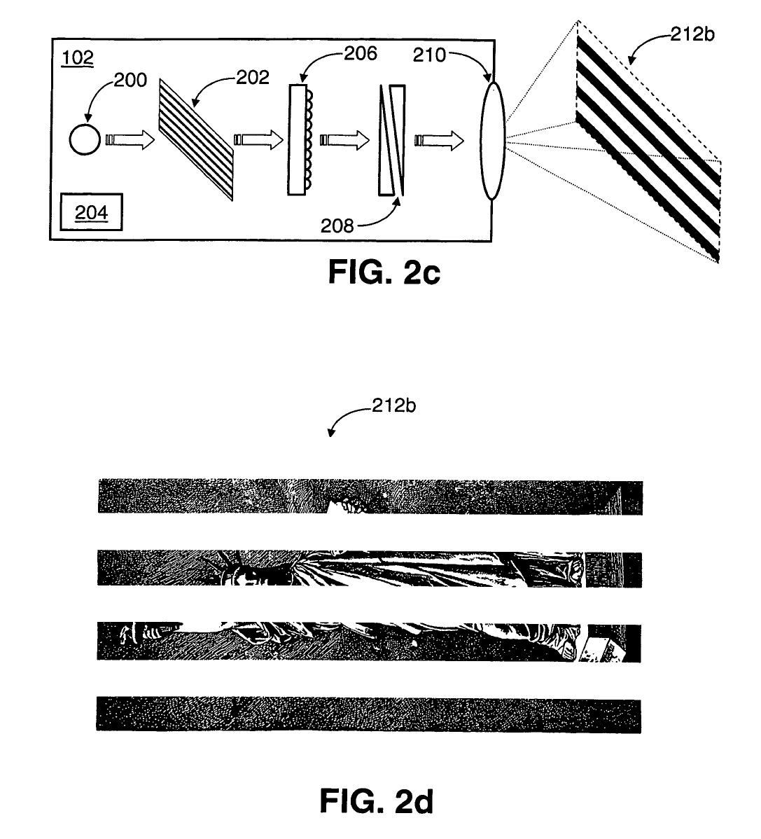

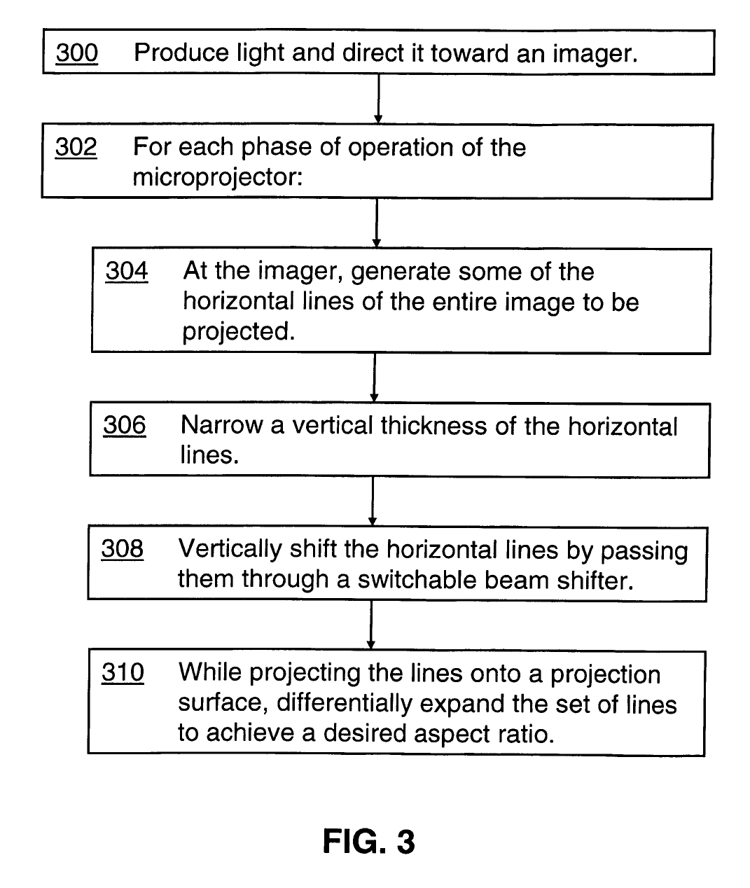

FIG. 2a gives an example of how a microprojector made according to aspects of the present invention can achieve a high resolution in the projected image 104. FIG. 3 also illustrates embodiments of the present invention by following light through the microprojector system. To begin, an illumination source 200 produces light which is directed toward an imager 202 (Step 300 of FIG. 3).

In some embodiments, the horizontal resolution of the imager 202 is equal to the horizontal resolution of the projected image 104, but the vertical resolution of the imager 202 is only a fraction (e.g., ½) of the vertical resolution of the projected image 104. To produce the projected image 104, the microprojector system moves sequentially through a cycle of phases of operation (Step 302 of FIG. 3). During each phase of operation, the imager 202 projects a portion of the final image 104 (Step 304). In the course of one full cycle, the entire image 104 is projected.

FIGS. 2a through 2d illustrate the operation of an exemplary microprojector system with exactly two phases of operation. During the first phase of operation, as illustrated in FIG. 2a, the controller logic and image memory 204 directs the imager 202 to modulate the light directed to it in order to display only the odd-numbered lines of the desired image (Step 304 of FIG. 3).

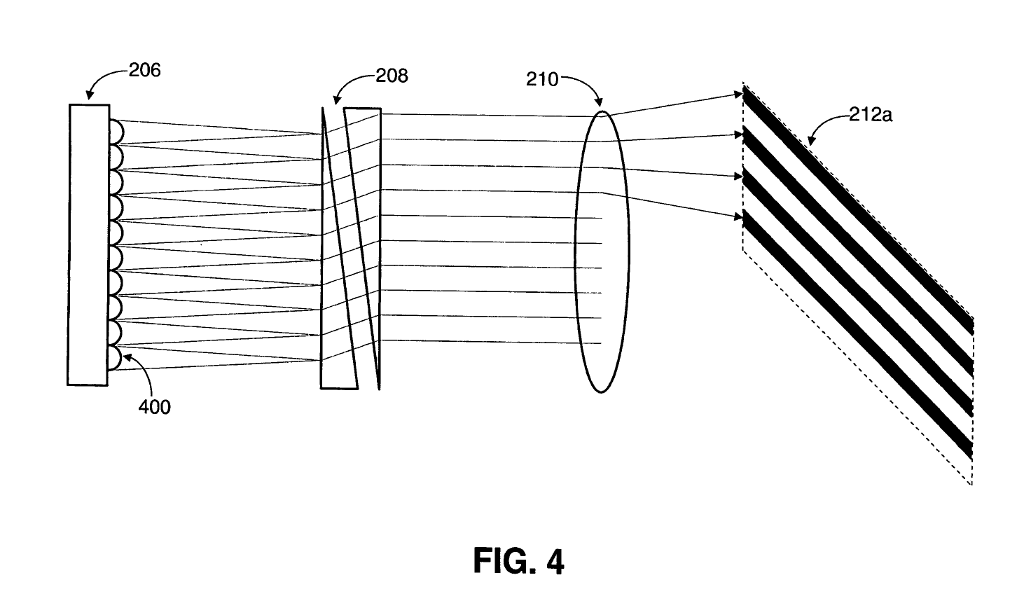

It is important that the lines projected during each phase of operation are not projected on top of the lines projected during other phases of operation. Two functional elements, line-processing optics 206 and a switchable beam shifter 208, are provided in some embodiments to ensure this. The immediately following discussion presents an overview of the functions of these elements, while FIG. 4 and its accompanying text illustrate their operations in greater detail.

During the first phase of operation as illustrated in FIG. 2a, the odd-numbered lines pass through the line-processing optics 206 where their vertical thickness is narrowed (Step 306 of FIG. 3). This narrowing will allow room in the final projected image 104 for the even-numbered lines to fit between these odd-numbered lines. The vertically narrowed, odd-numbered lines then pass on to the switchable beam shifter 208.

The switchable beam shifter 208 also moves sequentially through a cycle of phases. During the first phase as illustrated in FIG. 2a, the switchable beam shifter 208 moves the vertically narrowed, odd-numbered lines up a bit (Step 308 of FIG. 3). When projected through a projection lens system 210 (Step 310), the result is the partial image 212a. In FIG. 2a, the thick black lines of the partial image 212a represent the odd-numbered lines of the final image 104, that is to say, these are the lines that are projected during the first phase of operation. The thick white lines of the partial image 212a are gaps between the projected lines; these gaps are produced by the vertical narrowing of the line-processing optics 206. (The differential expansion of the lines mentioned in Step 310 is discussed below in reference to FIG. 4.)

FIG. 2b represents the result of the first phase of operation, in a highly stylized manner. The odd-numbered lines projected during this phase of operation are shown as four horizontal bands making up the partial image 212a. In actual operation, it is expected that these bands will each be only one pixel wide, and that there will be many more than four of them. The resolution of a VGA display, for example, is 640×480 pixels. Then, for a microprojector with exactly two phases of operation, the partial image 212a will consist of 240 horizontal lines of pixels, each 640 pixels wide, with a single pixel-width blank line between each adjacent pair of projected horizontal lines. Embodiments of the present invention are compatible with other image resolutions.

To complete this example of a microprojector with exactly two phases of operation, turn to FIGS. 2c and 2d. During the second phase of operation, the controller logic 204 directs the imager 202 to image only the even-numbered lines of the desired image 104. The line-processing optics 206 narrow the vertical thickness of these even-numbered lines. The switchable beam shifter 208 now moves to its other state, so that the vertically narrowed, even-numbered lines, after passing through the projection lens system 210, are projected into the gaps left between the odd-numbered lines projected during the first phase of operation.

FIG. 2d shows, again very stylistically, four even-numbered bands in the partial display 212b.

When the microprojector system moves through its cycle of states very rapidly (e.g., 24 or 32 full cycles are completed in every second), then the human eye cannot distinguish the separate partial images 212a and 212b. Instead, these partial images 212a and 212b combine visually into a seamless, flicker-free, projected image 104.

Because the imager 202 presents multiple partial images during each full cycle of operation, the imager 202 can be shorter in a vertical direction than a monolithic imager of the same overall resolution. This permits the personal portable device 102 to remain small and thin. There is no need to include in the personal portable device 102 room for a single monolithic imager that has the same resolution as the final image 104. Instead, the system of FIGS. 2a and 2c operates in such a way that the resolution of the final image 104 is the sum of the resolutions of the partial images produced during one full cycle of operation. The imager 202 has a horizontal resolution equal to the horizontal resolution of the overall image 104. If exactly two phases of operation are used in the system of FIGS. 2a and 2c, then the imager 202 has half the vertical resolution of the overall image 104. Therefore, this imager 202 can, during a full cycle of operation, produce the total resolution of the overall image 104. In this case, the thickness of the personal portable device 102 is constrained only by the vertical dimension of the “half-height” imager 202 rather than by the vertical dimension of a “full-height” monolithic imager.

Other embodiments use more than two phases of operation during a full cycle. This allows the imager 202 to be even thinner, at the possible cost of either decreasing the quality of the projected image 104 or of increasing the cycle rate. With four phases of operation, for example, the imager 202 produces only ¼ of the overall number of horizontal lines per cycle, but there may need to be 48 or more cycles every second in order to produce acceptable image quality.

The imager 202 shown in FIGS. 2a and 2c is called a “transmissive” imager because it modulates light as the light passes through the imager 202. “Reflective” imagers are also known and can be used in embodiments of the present invention. Reflective imagers modulate light as it reflects off of them. The choice to use reflective or transmissive imagers is based on packaging and other considerations.

For simplicity's sake, the projection lens system 210 is drawn as a single lens in FIG. 2a (and in FIGS. 2c and 4). As is well known in the art, a projection lens system 210 can include numerous lenses of different curvatures and materials. Different projection lens systems 210 are chosen based on physical constraints and on anticipated use.

Note again that “vertical” and “horizontal” are used here merely for convenience' sake and are used with respect to the figure under discussion. In most embodiments, the image 104 is expected to be projected from an end face of the personal portable device 102. The shape of the end face of many personal portable devices 102 approximates a long, thin rectangle. In some embodiments of the present invention, the projected image 104 roughly follows this shape. Thus, to project an image in “landscape” mode (that is, with a greater horizontal than a vertical dimension), the user 100 holds her personal portable device 102 “flat” (with the long edge of the face of the device 102 parallel to the ground). To project an image 104 in the “portrait” mode as shown in FIG. 1, the user 100 turns her personal portable device 102 so that the long edge of its end face is vertical. Known technology can be used to tell the personal portable device 102 of its orientation so that it can project the image 104 appropriately.

FIG. 4 is a more detailed view of some of the components shown in FIGS. 2a and 2c. In the particular embodiment of FIG. 4, the line-processing optics 206 include an array of “lenslets” 400, one per horizontal line produced by the imager 202. The light paths in FIG. 4 show how the lenslets 400 narrow the vertical thickness of the lines produced by the imager 202 before those lines reach the switchable beam shifter 208. Other devices for narrowing lines are known and can be used in some embodiments of the invention.

In some embodiments, the imager 202 consists of (1) areas that actually create images separated by (2) “blanks” or areas that do not create any image. In these embodiments, second line-processing optics (not shown) can be placed between the illumination source 200 and the imager 202. These optics serve to concentrate incident light only on the image-producing areas of the imager 202 so that no light is wasted.

The switchable beam shifter 208 of FIG. 4 is shown directing the image lines upward a little bit before they reach the projection lens system 210. In another phase of operation the switchable beam shifter 208 can move the lines downward a little bit. In some embodiments, the switchable beam shifter 208, in one phase of operation, directs the lines straight through to the projection lens system 210. Several known techniques are suitable for creating the switchable beam shifter 208 including one or more optical wedges, a liquid-crystal steering device, an electrowetting beam bender, and an ultrasonically driven oscillating mirror. These and other usable techniques have the virtues of a fast enough switching speed, an adequate deviation angle, low power consumption, and low volume in the personal portable device 102.

The projection lens system 210 of FIG. 4 is shown projecting the image lines to their appropriate locations on the partial image 212a. (Remember that the thick black lines of the partial image 212a represent the lines projected during this phase of operation.)

The microprojector system as described so far would, in some embodiments, produce a final image 104 with an incorrect aspect ratio. (The aspect ratio is defined to be the ratio of the horizontal dimension of the image 104 to its vertical dimension.) For example, in the case where the microprojector has exactly two phases of operation during each cycle, the vertical dimension of the final image 104 will only be about half what it should be in relation to the image 104's horizontal dimension. To compensate for this, in some embodiments, the projection lens system 210 is anamorphic. The anamorphic projection lens system 210 expands the set of projected lines more in a vertical direction than in a horizontal direction (Step 310 of FIG. 3). In the embodiment where the microprojector has exactly two phases, the anamorphic projection lens system 210 can be configured to expand the vertical dimension of the projected partial images 212a, 212b twice as much as it expands their horizontal dimension. In embodiments with more phases, the anamorphic projection lens system 210 can be configured to achieve the desired aspect ratio.

In view of the many possible embodiments to which the principles of the present invention may be applied, it should be recognized that the embodiments described herein with respect to the drawing figures are meant to be illustrative only and should not be taken as limiting the scope of the invention. For example, the light paths in the figures are only meant to illustrate the functions of the various components and are not meant to be definitive. Other arrangements of the optical components shown in the figures and the addition of other known optical components are possible and may be called for in various environments. Therefore, the invention as described herein contemplates all such embodiments as may come within the scope of the following claims and equivalents thereof.

We claim:

1. An image projector comprising:
an illumination system configured for directing light along a path toward an imager;
the imager configured for modulating light in a light path, the modulated light comprising a plurality of horizontal lines of pixels;
line-processing optics configured for narrowing a vertical thickness of the lines of pixels of modulated light from the imager;
a switchable beam shifter configured for cyclically moving among a plurality of states, in each state the switchable beam shifter configured for shifting the narrowed lines of pixels by an amount specific to the state, and for directing the shifted, narrowed lines of pixels toward an anamorphic projection lens system; and
the anamorphic projection lens system configured for expanding the lines of pixels in a vertical direction and in a horizontal direction, the vertical expanding being greater than the horizontal expanding, the anamorphic projection lens system also configured for projecting the lines of pixels.

2. The image projector of claim 1 wherein the imager is selected from the group consisting of: a reflective imager and a transmissive imager.

3. The image projector of claim 1 wherein the line-processing optics comprise an array of lenslets.

4. The image projector of claim 1 wherein the switchable beam shifter comprises an element selected from the group consisting of: a wedge element, a liquid-crystal steering device, an electrowetting beam bender, and an oscillating mirror.

5. The image projector of claim 1 wherein the lines of pixels projected sequentially during a full cycle of movement of the switchable beam shifter among its plurality of states visually combine into a combined image.

6. The image projector of claim 5 wherein the switchable beam shifter moves between exactly two states during a full cycle of movement, and wherein the narrowed lines of pixels are shifted higher in one state than in the other state.

7. The image projector of claim 6 wherein lines of pixels projected during one state of the switchable beam shifter comprise odd-numbered lines of the combined image, and wherein lines of pixels projected during another state of the switchable beam shifter comprise even-numbered lines of the combined image.

8. The image projector of claim 5 wherein a resolution of the combined image is a sum of resolutions of the lines of pixels projected during the states in a full cycle of movement of the switchable beam shifter.

9. The image projector of claim 8 wherein the resolution of the combined image is a product of a horizontal resolution of the combined image and a vertical resolution of the combined image, wherein the horizontal resolution of the combined image equals a horizontal resolution of lines of pixels projected during a state in the cycle of the switchable beam shifter, and wherein the vertical resolution of the combined image equals a sum of vertical resolutions of lines of pixels projected during the states in a full cycle of the switchable beam shifter.

10. The image projector of claim 1 further comprising:
second line-processing optics between the illumination system and the imager.

11. A method for projecting an image, the method comprising:
producing light;
modulating the light, the modulated light comprising a plurality of horizontal lines of pixels;
narrowing a vertical thickness of the lines of pixels of modulated light;
cyclically moving among a plurality of states, in each state shifting the narrowed lines of pixels by an amount specific to the state;
directing the shifted, narrowed lines of pixels toward a projection lens system; and
projecting the lines of pixels, the projecting comprising expanding the lines of pixels in a vertical direction and in a horizontal direction, the vertical expanding being greater than the horizontal expanding.

12. The method of claim 11 wherein modulating the light comprises transmitting light through an imager.

13. The method of claim 11 wherein modulating the light comprises reflecting light off an imager.

14. The method of claim 11 wherein the lines of pixels projected sequentially during a full cycle of movement among the plurality of states visually combine into a combined image.

15. The method of claim 14 wherein the plurality of states comprises exactly two states during a full cycle of movement, and wherein the narrowed lines of pixels are shifted higher in one state than in the other state.

16. The method of claim 15 wherein lines of pixels projected during one state of the plurality of states comprise odd-numbered lines of the combined image, and wherein lines of pixels projected during another state of the plurality of states comprise even-numbered lines of the combined image.

17. The method of claim 14 wherein a resolution of the combined image is a sum of resolutions of the lines of pixels projected during the states in a full cycle of movement.

18. The method of claim 17 wherein the resolution of the combined image is a product of a horizontal resolution of the combined image and a vertical resolution of the combined image, wherein the horizontal resolution of the combined image equals a horizontal resolution of lines of pixels projected during a state in the cycle, and wherein the vertical resolution of the combined image equals a sum of vertical resolutions of lines of pixels projected during the states in a full cycle of movement.

19. A personal portable device, the device comprising:
a memory configured for storing image information; and
an image projector, the image projector comprising:
an illumination system configured for directing light along a path toward an imager;
the imager configured for modulating light in a light path, the modulated light comprising a plurality of horizontal lines of pixels;
line-processing optics configured for narrowing a vertical thickness of the lines of pixels of modulated light from the imager;
a switchable beam shifter configured for cyclically moving among a plurality of states, in each state the switchable beam shifter configured for shifting the narrowed lines of pixels by an amount specific to the state, and for directing the shifted, narrowed lines of pixels toward an anamorphic projection lens system; and
the anamorphic projection lens system configured for expanding the lines of pixels in a vertical direction and in a horizontal direction, the vertical expanding being greater than the horizontal expanding, the anamorphic projection lens system also configured for projecting the lines of pixels.

20. The personal portable device of claim 19 wherein the device is selected from the group consisting of: a cellular telephone, a personal digital assistant, and a personal computer.

21. The personal portable device of claim 19 further comprising:
a controller configured for cyclically moving among a plurality of states, in each state the controller configured for sending to the imager a plurality of lines of pixels of an image, the plurality of lines of pixels sent during one state forming a subset of the image, the controller further configured for sending all of the lines of pixels of the image to the imager during one full cycle of states of the controller.
